(19) United States
(12) Patent Application Publication
(10) Pub. No.: US 2008/0014506 A1
(43) Pub. Date: Jan. 17, 2008

(54) Separator for lead-acid battery, pasting paper for lead-acid battery, plate for lead-acid battery and lead-acid battery

(75) Inventors: Shoji Sugiyama, Tokyo (JP); Yoshinobu Kakizaki, Tokyo (JP); Takashi Shidomi, Tokyo (JP)

Correspondence Address: KRATZ, QUINTOS & HANSON, LLP, 1420 K Street, N.W., Suite 400, WASHINGTON, DC, 20005, US

(73) Assignee: NIPPON SHEET GLASS COMPANY, LIMITED, Tokyo (JP)

(21) Appl. No.: 11/785,635

(22) Filed: Apr. 19, 2007

(30) Foreign Application Priority Data
Apr. 19, 2006 (JP) 2006-115757

(51) Int. Cl. H01M 2/16

(52) U.S. Cl. 429/246; 429/247

(57) ABSTRACT

A separator for a lead-acid battery, a pasting paper for a lead-acid battery, a plate for a lead-acid battery, and a lead-acid battery using the same are disclosed. The separator comprises a microporous sheet containing a heavy metal adsorbent comprising a rare earth compound having high heavy metal adsorbability in a neutral region and low heavy metal adsorbability in an acidic region, wherein the heavy metal adsorbent is unevenly distributed in a thickness direction of the sheet, thereby forming the heavy metal adsorbent-containing layer extending in a horizontal direction of the sheet and a layer which does not substantially contain the heavy metal adsorbent.

### BACKGROUND OF THE INVENTION

1. Field of the Invention

The present invention relates to a separator for a lead-acid battery, a pasting paper for a lead-acid battery, a plate for a lead-acid battery and a lead-acid battery using the same.

2. Background Art

In battery jar formation which is becoming a mainstream of a production method of a lead-acid battery, when an electrolyte pours into the jar, sulfuric acid reacts with a plate active material, and specific gravity of the electrolyte approaches 1.0. Further, even in the case of allowing a battery to stand with overcharging, specific gravity of an electrolyte lowers. Thus, when the electrolyte approaches a neutral region, lead in an electrode dissolves in the electrolyte as ions, and diffuses in a separator. When charging thereafter, specific gravity of the electrolyte increases and the electrolyte gradually returns to an acidic region. However, lead ions dissolved are dendritically crystallized as pure lead at a negative electrode side, as lead dioxide at a positive electrode side, and as lead sulfate in a separator (this is called dendrite). When the grown dendrite connects between a positive electrode and a negative electrode, short circuit (dendrite short circuit) is generated, resulting in defective battery. Such a dendrite short circuit is particularly easily generated in a valve-regulated lead-acid battery containing a small amount of an electrolyte.

Conventionally, as a method of suppressing dendrite short circuit, Patent Document 1 proposes a method of using a non-woven fabric having an ion-exchange function which adsorbs heavy metals. Specifically, the non-woven fabric is an ion-exchanged resin non-woven fabric with functional groups such as a carboxyl group (—COOH) and a sulfone group (—SO₃H) that can capture heavy metals, and it is considered that lead ions are captured in the form of (—COO)₂Pb and (—SO₃)₂Pb, thereby suppressing growth of dendrite. Similarly, it is considered that a phosphate group (—PO₃H) and a phenolic hydroxyl group (—OH) are also effective.

However, in the case of the dendrite short circuit suppression method of Patent Document 1, materials are all organic compounds. Such compound is deteriorated in sulfuric acid and cannot respond to oxidation/deformation due to nascent oxygen, therefore a long-term dendrite suppression effect cannot be maintained. Further, a material having a carboxyl group, a phosphate group or the like is modified into an organic acid, thereby deteriorating a plate, and this gives rise to the problem of shortening a battery life.

As a dendrite short circuit suppression method using an organic material, Patent Document 2 proposes a lead-acid battery wherein SiO₂ or SiO₂.nH₂O which can capture lead sulfate is present on one surface layer of a plate. That is to say, it is considered that SiO₂ or SiO₂.nH₂O captures lead sulfate, thereby suppressing growth of dendrite. Certainly, SiO₂ or SiO₂.nH₂O shows acid resistance to sulfuric acid, and stability can be maintained over a long period of time. Therefore, this is advantageous as compared with the method of Patent Document 1. However, with regard to the dendrite short circuit suppression effect which is considered to capture lead sulfate and suppress dendrite growth, practically it is appropriate as its principle to consider due to that a specific surface area of SiO₂ or SiO₂.nH₂O is 100 g/m² or more which is 50 times larger than that of a glass fiber, and this can make growth path of dendrite complicated and long, thereby physically delaying dendrite growth. Since lead sulfate eluted is not chemically fixed, dendrite short circuit is ultimately generated.

Patent Document 1: JP-A-2001-222987

Patent Document 2: JP-A-2001-190686

As a result, it is considered that a method of introducing an inorganic material which can adsorb and fix heavy metals, into the inside of a battery as a dendrite prevention layer is desirable. Examples of a method of utilizing an inorganic material which adsorb heavy metals include an active alumina method, a coagulation filtration method which adds a metal salt such as iron chloride and aluminum salt to form a floc, and removing the same, and an iron compound method which uses iron hydroxide. However, any of those methods have the problems that a metal component disturbs cell reaction, and optimum pH treatment (acid and alkali agent addition) is required to adsorb lead. Thus, in a lead-acid battery using a sulfuric acid electrolyte, it is substantially impossible to control pH, and it causes some trouble in practical application. Heavy metals that brings problem to a lead-acid battery include antimony as well as lead. Antimony increases lattice strength and enhances bonding of mutual active materials and between a lattice and an active material in a lead-acid battery which is for deep discharging of a flooded type battery and is used in cycle usage, and is therefore greatly utilized in such a lead-acid battery. However, there are the problems that antimony elutes in an electrolyte during overdischarging, and precipitates on a negative electrode during charging, thereby decreasing hydrogen evolution potential, decomposition of an electrolyte increases and replenishment of water is required in a flooded type battery, and the problems that in a valve regulated battery, battery life is shortened due to lack of an electrolyte and it is detrimental to sealing work due to increase of gas generation.

Other heavy metals have the possibility to be a causative material which disturbs cell reaction to decrease capacity of a battery. Therefore, with respect to heavy metals in a plate, an electrolyte and a separator, standard is set in every battery maker for regulation.

### SUMMARY OF THE INVENTION

Accordingly, the present invention has objects to provide a separator for a lead-acid battery, a pasting paper for a lead-acid battery, a plate for a lead-acid battery, and a lead-acid battery using the same, that can timely capture heavy metals that bring defects to a lead-acid battery, particularly lead which is a causative material of dendrite short circuit and antimony which is a causative material of decrease in an electrolyte, and can suppress defects such as dendrite short circuit and decrease in an electrolyte due to those heavy metals, without bringing adverse effects such as deterioration of other properties, and further without applying a specific treatment or control to a battery.

As a result of keen investigations to achieve the above objects, the present inventors have focused attention on a rare earth compound as an inorganic material which adsorbs heavy metals. The rare earth compound has the ability to adsorb heavy metals such as arsenic, fluorine, chromium, cadmium, lead and antimony, but has the properties that its adsorbability is high in a neutral region and an alkaline region, and low in an acidic region. Utilizing this property, the present inventors have found as follows. Where the rare earth compound is provided at an appropriate site contacting with an electrolyte in a lead-acid battery, when specific gravity of the electrolyte decreases during battery jar formation or overdischarging to become a neutral region or approach a neutral region, lead in an electrode becomes easy to dissolve out as ions, but because absorbability of the rare earth compound is high, the rare earth compound can adsorb and capture lead ions dissolved out, thereby suppressing dendrite growth. On the other hand, in an acidic region having high specific gravity of an electrolyte, lead ions generated from lead and lead dioxide during discharging rapidly react with sulfate ions to from lead sulfate. However, because adsorbability of the rare earth compound is low, the rare earth compound does not adsorb and capture lead ions generated, and as a result, cell reaction cannot be disturbed. Thus, it was found that the rare earth compound can be used ideally.

The present invention is an invention that has been made based on the finding. According to a first aspect of the invention, there is provided a separator for a lead-acid battery comprising a microporous sheet containing a heavy metal adsorbent comprising a rare earth compound having high heavy metal adsorbability in a neutral region and low heavy metal adsorbability in an acidic region, wherein the heavy metal adsorbent is unevenly distributed in a thickness direction of the sheet, thereby forming the heavy metal adsorbent-containing layer extending in a horizontal direction of the sheet and forming a layer which does not substantially contain the heavy metal adsorbent.

In detail, when the heavy metal adsorbent is provided in a separator, care should be taken. When the heavy metal adsorbent is uniformly provided in the separator entirely, dendrite growth which connects between a positive electrode and a negative electrode is easy to occur in dendrite growth by lead, and the effect of suppressing dendrite short circuit is not obtained. Therefore, when the heavy metal adsorbent is locally provided in the separator so as to form a heavy metal adsorbent-containing layer extending to a horizontal direction of the separator and a layer which does not substantially contain the heavy metal adsorbent, lead ions can be adsorbed on and fixed to the heavy metal adsorbent-containing layer in a concentrated manner, and cannot substantially be adsorbed on and fixed to the layer which does not substantially contain the heavy metal adsorbent. As a result, adsorption and fixation site of lead ions can discontinuously be changed in a thickness direction of the separator, and consequently, this makes it difficult to generate dendrite growth which penetrates in a thickness direction of the separator to connect between a positive electrode and a negative electrode.

In a second aspect of the invention, there is provided the separator for a lead-acid battery of the first aspect, wherein the heavy metal adsorbent is contained in only a surface layer at one side of the sheet. In detail, to locally providing the heavy metal adsorbent in the separator so as to form the heavy metal adsorbent-containing layer extending to a horizontal direction of the separator and a layer which does not substantially contain the heavy metal adsorbent, a method of applying a solution of the heavy metal adsorbent to the separator is most preferable. Further, when the solution is applied to only one side of the separator, the objects of the present invention, that is, the effects of suppressing dendrite short circuit by the capture of lead and suppressing decrease in an electrolyte by the capture of antimony, can sufficiently be achieved. Application of the solution to both sides of the separator is disadvantageous in ease of production and production cost, and additionally, it is disadvantageous in that formation of the layer which does not substantially contain the heavy metal adsorbent is not sufficient (for example, when thickness of the layer which does not substantially contain the heavy metal adsorbent is insufficient, the effect of suppressing dendrite growth which connects between a positive electrode and a negative electrode becomes insufficient). For the above reason, it is desirable to contain the heavy metal adsorbent in only a surface layer at one side of the separator.

According to a third aspect of the invention, there is provided a pasting paper for a lead-acid battery containing a heavy metal adsorbent comprising a rare earth compound having high heavy metal adsorbability in a neutral region and low heavy metal adsorbability in an acidic region.

According to a fourth aspect of the invention, there is provided a plate for a lead-acid battery which uses the above pasting paper for a lead-acid battery.

According to a fifth aspect of the invention, there is provided a plate for a lead-acid battery which uses an active material containing a heavy metal adsorbent comprising a rare earth compound having high heavy metal adsorbability in a neutral region and low heavy metal adsorbability in an acidic region.

According to a sixth aspect of the invention, there is provided a lead-acid battery which uses the separator for a lead-acid battery of the first aspect.

In a seventh aspect of the invention, there is provided the lead-acid battery of the sixth aspect of the invention, wherein the separator is arranged such that a side containing more heavy metal adsorbent faces toward a negative plate side. Since dendrite generation occurs normally on the negative plate, dendrite growth inhibition effect is enhanced by arranging such that the side containing more heavy metal adsorbent faces toward the negative plate side.

According to an eighth aspect of the invention, there is provided a lead-acid battery which uses the plate for a lead-acid battery as described above.

The lead-acid battery according to the present invention is that cerium oxide hydrate or cerium hydroxide of a rare earth compound which is a heavy metal adsorbent capturing lead and antimony eluted in an electrolyte, and other heavy metals is unevenly distributed in a thickness direction of a separator. Specifically, the heavy metal adsorbent is adhered to only a surface layer, or is mixed in a pasting paper and the paper is adhered to a plate surface. Adhering the heavy metal adsorbent to the plate surface contributes to stabilize battery performance and to improve battery life in that dendrite generated in the inside of a separator during battery jar formation is prevented by an adsorption layer of cerium oxide hydrate or cerium hydroxide of the rare earth compound adhered, thereby preventing dendrite short circuit, and reduction in an electrolyte due to precipitation of antimony from an electrode using antimony is suppressed.

Short time and high output are required in recent sealed battery for UPS and the like, and in many cases, high output is achieved by increasing the number of plates. However, this narrows a distance between the plates, and as a result, dendrite short circuit is liable to occur. Therefore, when the lead-acid battery of the present invention is applied, the problem can be overcome, and remarkable effect is obtained industrially.

### DETAILED DESCRIPTION OF THE INVENTION

When the rare earth compound is held on a plate surface and one side of a separator, means for overcoming those problems is obtained. However, the rare earth compound is an inorganic solid. Therefore, it is difficult to dissolve the solid in the plate, and in an electrolyte, the solid is precipitated on the bottom. In fact, dendrite is generated in the inside of the separator, and it is therefore most preferable to use a method of adhering the rare earth compound to one side of a separator or a method of adhering the same to a plate surface.

Specific rare earth compounds are oxides or hydroxides of rare earths, and examples thereof include cerium oxide (CeO₂.1.6H₂O), samarium oxide hydrate (Sm₂O₃4.1H₂O), neodymium oxide hydrate (Nd₂O₃.4.7H₂O), lanthanum oxide hydrate (La₂O₃.3.0H₂O), yttrium oxide hydrate (Y₂O₃.2.1H₂O) and cerium hydroxide (Ce(OH)₃ or Ce(OH)₄). The rare earth compound is provided in the form of a fine powder having a particle diameter of from about 0.1 to 2 μm. Considering industrial use, it is preferable to use a cerium compound which can be available inexpensively in rare earth compounds.

The heavy metal adsorbent may directly use the fine powder of the rare earth compound. In general, commercially available powders or fibers having the rare earth compound supported on the surface thereof are used. Examples of a carrier that can be used include inorganic materials such as a silica powder, silica sol, glass fibers and ceramic fibers, and organic materials such as a polyolefin resin, an acrylonitrile resin and a polyester resin.

The separator for a lead-acid battery is generally a polyethylene separator obtained by an extrusion molding method and a synthetic pulp separator obtained by wet papermaking method in a flooded type battery, and AGM separator obtained by a wet papermaking method in a valve regulated battery.

Coating method is preferable to adhere and contain the heavy metal adsorbent to and in microporous sheets which are those separators so as to unevenly distribute the heavy metal adsorbent in a thickness direction as described above. In the case of a polyethylene separator, because the heavy metal adsorbent is in the form of a fine powder, it can be dispersed in a solvent, and the resulting dispersion can be applied. In the case of a synthetic pulp separator and AGM separator, use of a coating method can form a heavy metal adsorption layer on only the surface of the separator. Further, to further surely and further easily (in the point of control of production) obtain a separator comprising a microporous sheet in which the heavy metal adsorbent-containing layer extending in a horizontal direction of the microporous sheet and a layer which does not substantially contain the heavy metal adsorbent are formed in a thickness direction of the microporous sheet, a heavy metal adsorbent-containing microporous sheet containing the heavy metal adsorbent dispersed in the microporous sheet entirely without particularly localizing the heavy metal adsorbent in the microporous sheet, and a heavy metal adsorbent-free microporous sheet which does not contain the heavy metal adsorbent in a microporous sheet are provided, and those two sheets may be combined in a laminated state to form a separator. Specifically, in fabricating a battery by building a separator into a space between plates, the heavy metal adsorbent-containing microporous sheet and the heavy metal adsorbent-free microporous sheet are previously laminated by bonding, combination or the like to integrate those, and the integrated product is incorporated as a separator, or the heavy metal adsorbent-containing microporous sheet and the heavy metal adsorbent-free microporous sheet are merely combined in a laminated form without integrating, and the laminate is incorporated as a separator.

In the case of a pasting paper, it is not necessary to unevenly distribute the heavy metal adsorbent in a thickness direction as in the separator as described above. The heavy metal adsorbent is mixed in a raw material of a pasting paper together with a flocculating agent, and the resulting mixture is subjected to wet papermaking. This enables the heavy metal adsorbent to adhere to and support on a surface of the pasting paper raw material by the action of the flocculating agent. A mixing method is advantageous than the coating method in the points of ease of production and production cost. However, in the case of the pasting paper, use of the coating method does not give rise to any particular problem, and there is no problem on properties even though the heavy metal adsorbent is unevenly distributed on only the surface layer at one side (for example, dendrite growth suppression effect does not deteriorate).

One example of a method of forming a heavy metal adsorption layer on an AGM separator is described. The AGM separator is preferably produced using an inclined paper machine or Fourdrinier paper machine.

(1) As a raw material, for example, a predetermined amount of fine glass fibers having an average fiber diameter of 0.8 μm is weighed, and is uniformly dispersed and mixed in water by a separator such as a mixer or pulper. This papermaking raw material liquid is transported to a storage tank and stored therein.

(2) The papermaking raw material liquid is subjected to berry shatter, and then passed through a screen and a filter.

(3) Supply amount of the papermaking raw material liquid is controlled by a stock valve and a white water valve, the papermaking raw material liquid is injected from a head box through a step diffuser or the like to deposit on a running forming wire, and the deposited material is dehydrated from the lower portion to form a glass fiber sheet in a wet state.

(4) The sheet is passed through a drier to dry, thereby obtaining an AGM separator having a constant thickness.

(5) 5% aqueous solution of an acryl emulsion is prepared as a binder, and an aqueous solution is prepared by mixing 20% by weight of a cerium hydroxide fine powder as a heavy metal adsorbent with the solution. When the solution is applied to the AGM separator obtained above in an amount of 20 g/m² through a roll coater, the AGM separator having the heavy metal adsorption layer containing 4 g/m² of cerium hydroxide formed on only a surface layer at one side thereof is obtained. This separator is cut in conformity with a plate size of a valve regulated battery required, and incorporated in the battery.

(6) The sealed lead-acid battery is prepared as follows. A lead active material (a mixture of PbC, Pb and PbSO₄) is applied to a Pb—Ca alloy lattice to prepare two anodes and three cathodes. Four AGM separators are inserted among those electrodes, and the resulting assembly is mounted in a battery jar. In this case, the assembly is mounted so as to face the side on which the heavy metal adsorption layer of the AGM separator is formed, toward a cathode plate side.

(7) An electrolyte (diluted sulfuric acid) having specific gravity of 1.24 is poured in the battery prepared above, and after allowing to stand for 5 hours, battery jar formation is conducted at an electric current of 10 hours rate for 30 hours. After completion of the formation, the battery is disassembled, and short circuit state of the AGM separator is observed.

The present invention is described below by referring to Examples of the present invention together Comparative Examples and Conventional Examples.

### EXAMPLE 1

100% by weight of glass fibers having an average fiber diameter of 0.8 μm was subjected to wet papermaking by the method as described above, and dried with hot air to obtain an AGM separator having a thickness of 1.0 mm and a density of 0.14 g/CM³.

A 5 wt % aqueous solution of an acryl emulsion was prepared as a binder, and an aqueous solution was prepared by mixing 20% by weight of a cerium hydroxide fine powder with the solution. This solution was applied to the above-obtained AGM separator in an amount of 20 g/m² through a roll coater, and the AGM separator having the heavy metal adsorption layer containing 4 g/m² of cerium hydroxide formed on only a surface layer at one side thereof was obtained. This was designated the separator for a lead-acid battery of Example 1.

Further, a valve regulated battery was prepared using the separator obtained above by the method as described above, and battery jar formation was conducted by the method as described above.

### EXAMPLE 2

An AGM separator having a thickness of 1.0 mm and a density of 0.14 g/cm³ was obtained in the same manner as in Example 1.

A 5 wt % aqueous solution of an acryl emulsion was prepared as a binder, and an aqueous solution was prepared by mixing 50% by weight of a cerium hydroxide fine powder with the solution. This solution was applied to the above-obtained AGM separator in an amount of 20 g/m² through a roll coater, and the AGM separator having the heavy metal adsorption layer containing 10 g/m² of cerium hydroxide formed on only a surface layer at one side thereof was obtained. This was designated the separator for a lead-acid battery of Example 2.

Further, a valve regulated battery was prepared using the separator obtained above by the method described above, and battery jar formation was conducted by the method described above.

### COMPARATIVE EXAMPLE 1

An AGM separator having a thickness of 1.0 mm and a density of 0.14 g/cm³ was obtained in the same manner as in Example 1. This was designated a separator for a lead-acid battery of Comparative Example 1.

Further, a valve regulated battery was prepared using the separator obtained above by the method as described above, and battery jar formation was conducted by the method described above.

### CONVENTIONAL EXAMPLE 1

An AGM separator having a thickness of 1.0 mm and a density of 0.14 g/cm³ was obtained in the same manner as in Example 1. An aqueous solution containing 50% by weight of a resol-type phenolic resin having hydroxyl groups (PHENOLITE PE602; manufactured by DIC) was prepared. This solution was applied to the above-obtained AGM separator in an amount of 20 g/m² through a roll coater, and the AGM separator having the heavy metal adsorption layer containing 10 g/m² of the resol-type phenolic resin formed on only a surface layer at one side thereof was obtained. This was designated the separator for a lead-acid battery of Conventional Example 1.

Further, a valve regulated battery was prepared using the separator obtained above by the method as described above, and battery jar formation was conducted by the method described above.

### CONVENTIONAL EXAMPLE 2

An AGM separator having a thickness of 1.0 mm and a density of 0.14 g/cm³ was obtained in the same manner as in Example 1.

An aqueous solution containing 50% by weight of colloidal silica (SNOWTEX; manufactured by Nissan Chemical Industries, Ltd.) was prepared. This solution was applied to the above-obtained AGM separator in an amount of 20 g/m² through a roll coater, and the AGM separator having the heavy metal adsorption layer containing 10 g/m² of silica formed on only a surface layer at one side thereof was obtained. This was designated the separator for a lead-acid battery of Conventional Example 2.

Further, a valve regulated battery was prepared using the separator obtained above by the method as described above, and battery jar formation was conducted by the method described above.

### EXAMPLE 3

90% by weight of glass fibers having an average fiber diameter of 0.8 μm and 11% by weight of organic fibers as a binder were subjected to wet papermaking by the method as described before, and dried with hot air to obtain a pasting paper having a thickness of 0.20 mm and a density of 0.18 g/cm³. The organic fibers can use microfibrillated cellulose, heat-fusible synthetic fivers and the like, and the microfibrillated cellulose was used in this Example.

A 5 wt % aqueous solution of an acryl emulsion was prepared as a binder, and an aqueous solution was prepared by mixing 20% by weight of a cerium hydroxide fine powder with the solution. This solution was applied to the above-obtained pasting paper in an amount of 20 g/m² through a roll coater, and the pasting paper having the heavy metal adsorption layer containing 4 g/m² of cerium hydroxide formed on only a surface layer at one side thereof was obtained. This was designated the pasting paper for a lead-acid battery of Example 3.

Further, the pasting paper was contacted with both sides of a plate, a valve regulated battery was prepared using the separator of Comparative Example 1 by the method as described before, and battery jar formation was conducted by the method as described before. In this case, the pasting paper was provided in a manner such that the side on which the heavy metal adsorption layer was formed contacts with the plate surface.

### EXAMPLE 4

An appropriate amount of a polymeric flocculating agent was mixed with 80% by weight of glass fibers having an average fiber diameter of 0.8 μm, 10% by weight of organic fibers as a binder and 10% by weight of a cerium hydroxide fine powder. The resulting mixture was subjected to wet papermaking by the method as described before, and dried with hot air to obtain a pasting paper with a heavy metal adsorption layer containing 4 g/m² of cerium hydroxide, having a thickness of 0.19 mm and a density of 0.20 g/cm³. Similar to Example 3, microfibrillated cellulose was used as the organic fiber. This was designated the pasting paper for a lead-acid battery of Example 4.

Further, the pasting paper was contacted with both sides of a plate, a valve regulated battery was prepared using the separator of Comparative Example 1 by the method as described before, and battery jar formation was conducted by the method as described before.

### COMPARATIVE EXAMPLE 2

90% by weight of glass fibers having an average fiber diameter of 0.8 μm and 10% by weight of organic fibers as a binder were subjected to wet papermaking by the method as described before, and dried with hot air to obtain a pasting paper having a thickness of 0.21 mm and a density of 0.18 g/cm³. Similar to Example 3, microfibrillated cellulose was used as the organic fiber. This was designated the pasting paper for a lead-acid battery of Comparative Example 2.

Further, the pasting paper was contacted with both sides of a plate, a valve regulated battery was prepared using the separator of Comparative Example 1 by the method as described before, and battery jar formation was conducted with the method described before.

Each separator and each pasting paper obtained above were subjected to the following heavy metal adsorption test. The results obtained are shown in Tables 1 and 2, respectively.

Heavy Metal Adsorption Test

The following test was conducted to measure heavy metal adsorbability of a separator alone or a pasting paper alone. The standard solution used was the commercially available product (concentration: 1,000 ppm) for atomic absorption analysis.

10 g of a separator or pasting paper sample was collected, and 250 ml of an antimony standard solution 10 ppm solution was added thereto (2,500 μg). The mixture was swung for 30 minutes, and after centrifugal separation, a supernatant was collected. The residual amount of lead in the solution was measured with ICP quantitative analysis.

Similarly, 10 g of a separator or pasting paper sample was collected, and 250 ml of a lead standard solution 10 ppm solution was added thereto (2,500 μg). The mixture was swung for 30 minutes, and after centrifugal separation, a supernatant was collected. The residual amount of lead in the solution was measured with ICP quantitative analysis.

The following confirmation test was conducted to demonstrate that the heavy metal adsorption action can sufficiently be exhibited even in using a plate for a lead-acid battery in which the heavy metal adsorbent is contained in an active material, similar to the case that the heavy metal adsorbent was contained in the above-described separator or pasting paper. The results obtained are shown in Table 3.

Confirmation Test

100 g of lead sulfate as an active material was added to 250 g of water (25° C.), followed by stirring for 2 hours. The amount of lead ions dissolved in the solution was measured (initial lead amount). Next, 0.5 g of cerium hydroxide as a heavy metal adsorbent was added to the solution obtained above, followed by stirring for 2 hours. The amount of lead ions dissolved in the solution was measured (residual lead amount).

TABLE 1

| | | | | | | Comparative | Conventional | Conventional |
|---|---|---|---|---|---|---|---|---|
| Item | | | Unit | Example 1 | Example 2 | Example 1 | Example 1 | Example 2 |
| Basis weight of separator | | | g/cm² | 144 | 150 | 140 | 150 | 150 |
| Amount of adsorbent | | | g/cm² | 4 | 10 | — | 10 | 10 |
| | | | g/separator g | 0.28 | 0.33 | — | 0.33 | 0.33 |
| Kind of adsorbent | | | — | Cerium | Cerium | — | Phenolic | Colloidal |
| | | | | hydroxide | hydroxide | | resin | silica |
| Heavy metal | Antimony | Initial amount | μg | 2,500 | 2,500 | 2,500 | 2,500 | 2,500 |
| adsorption | | Residual | μg | 120 | 72 | 2,489 | 862 | 2,210 |
| test | | amount | | | | | | |
| | | Adsorption | % | 95 | 97 | 0 | 26 | 12 |
| | | rate | | | | | | |
| | Lead | Initial amount | μg | 2,500 | 2,500 | 2,500 | 2,500 | 2,500 |
| | | Residual | μg | 306 | 256 | 2,496 | 2,150 | 1,982 |
| | | amount | | | | | | |
| | | Adsorption | % | 88 | 90 | 0 | 14 | 21 |
| | | rate | | | | | | |

| | | | | | | |
|---|---|---|---|---|---|---|
| Short circuit after battery jar formation | — | None | None | Generated: | Generated: | Generated: |
| | | | | large | small | small |

TABLE 2

| | | | | | | Comparative |
|---|---|---|---|---|---|---|
| Item | | | Unit | Example 3 | Example 4 | Example 2 |
| Basis weight of pasting paper | | | g/cm² | 40 | 41 | 36 |
| Amount of adsorbent | | | g/cm² | 4 | 4 | — |
| | | | g/pasting | 0.30 | 0.29 | — |
| | | | paper g | | | |
| Kind of adsorbent | | | — | Cerium | Cerium | — |
| | | | | hydroxide | hydroxide | |
| Heavy metal | Antimony | Initial amount | μg | 2,500 | 2,500 | 2,500 |
| adsorption | | Residual | μg | 117 | 136 | 2,493 |
| test | | amount | | | | |
| | | Adsorption | % | 95 | 95 | 0 |
| | | rate | | | | |
| | Lead | Initial amount | μg | 2,500 | 2,500 | 2,500 |
| | | Residual | μg | 321 | 336 | 2,498 |
| | | amount | | | | |
| | | Adsorption | % | 87 | 87 | 0 |
| | | rate | | | | |

| | | | | |
|---|---|---|---|---|
| Short circuit after battery jar formation | — | None | None | Generated: |
| | | | | large |

TABLE 3

| Item | | | Unit | Constitution |
|---|---|---|---|---|
| Amount of lead sulfate | | | g | 100 |
| Amount of adsorbent | | | g | 0.5 |
| Kind of adsorbent | | | — | Cerium |
| | | | | hydroxide |
| Confirmation test | Lead | Initial amount | μg | 1,890 |
| | | Residual amount | μg | 178 |
| | | Adsorption rate | % | 91 |

The following facts are understood from the results shown in Tables 1 to 3.

(1) The AGM separator having cerium hydroxide as the heavy metal adsorbent of Examples 1 and 2 applied to one side thereof has adsorption rate of antimony and lead of 88 to 97%, and it was confirmed that the adsorption effect is high. Further, in the battery test using the pasting paper or plate which is not provided with specific heavy metal adsorption mechanism and dendrite suppression mechanism, short circuit due to dendrite growth of lead is not generated, and it was confirmed that dendrite suppression effect by the separator of the present invention is high.

(2) Because the separator of Comparative Example 1 is not provided with the heavy metal adsorption mechanism, adsorption rate of antimony and lead was almost zero. Therefore, it was observed that short circuit is generated in the battery test, and much lead sulfate is generated.

(3) The separator of Conventional Example 1 is that a phenolic resin is applied to form a heavy metal adsorption layer, and a certain adsorption effect of antimony and lead is recognized. However, as compared with the Examples, the effect is low. Therefore, it is understood that short circuit cannot be prevented even in the battery test. However, the degree of generation of lead sulfate was low as compared with Comparative Example 1.

(4) The separator of Conventional Example 2 is that colloidal is applied to form a heavy metal adsorption layer, and a certain adsorption effect of antimony and lead is recognized. However, as compared with the Examples, the effect is low. Therefore, it is understood that short circuit cannot be prevented even in the battery test. However, the degree of generation of lead sulfate was low as compared with Comparative Example 1. The effect of physically delaying dendrite did not greatly differ from Conventional Example 1 on appearance.

(5) The pasting papers containing cerium hydroxide as the heavy metal adsorbent of Examples 3 and 4 are that the adsorption rate of antimony and lead is 87 to 95%, and it was confirmed that the adsorption effect is high. Further, in the battery test using the separator or active material which is not provided with specific heavy metal adsorption mechanism and dendrite suppression mechanism, short circuit due to dendrite growth of lead is not generated, and it was confirmed that dendrite suppression effect by the pasting paper of the present invention is high.

(6) Because the pasting paper of Comparative Example 2 is not provided with the heavy metal adsorption mechanism, adsorption rate of antimony and lead was almost zero. Therefore, it was observed that short circuit is generated in the battery test, and much lead sulfate is generated. In the battery test of Comparative Example 2, any of the separator, the pasting paper, the active material and the plate are not provided with specific heavy metal adsorption mechanism and dendrite suppression mechanism, and the conditions are substantially close to those of Comparative Example 1.

(7) As a result of the confirmation test confirming the heavy metal adsorption effect of the active material containing the heavy metal adsorbent, the adsorption rate of lead is 91%, and it was confirmed that the adsorption effect is high.

1: A separator for a lead-acid battery, comprising a microporous sheet containing a heavy metal adsorbent comprising a rare earth compound having high heavy metal adsorbability in a neutral region and low heavy metal absorbability in an acidic region, wherein the heavy metal adsorbent is unevenly distributed in a thickness direction of the sheet, thereby forming the heavy metal adsorbent-containing layer extending in a horizontal direction of the of sheet and forming a layer which does not substantially contain the heavy metal adsorbent.

2: The separator for a lead-acid battery as claimed in claim 1, wherein the heavy metal adsorbent is contained in only a surface layer at one side of the sheet.

3: A pasting paper for a lead-acid battery, containing a heavy metal adsorbent comprising a rare earth compound having high heavy metal adsorbability in a neutral region and low heavy metal adsorbability in an acidic region.

4: A plate for a lead-acid battery, using the pasting paper for a lead-acid battery as claimed in claim 3.

5: A plate for a lead-acid battery, using an active material containing a heavy metal adsorbent comprising a rare earth compound having high heavy metal adsorbability in a neutral region and low heavy metal adsorbability in an acidic region.

6: A lead-acid battery using the separator for a lead acid-acid battery as claimed in claim 1.

7: The lead-acid battery as claimed in claim 6, wherein the separator is arranged such that a side containing more heavy metal adsorbent faces toward a negative plate side.

8: A lead-acid battery using the plate for a lead-acid battery as claimed in claim 4.

9: A lead-acid battery using the plate for a lead-acid battery as claimed in claim 5.
